(19) United States
(12) Patent Application Publication
(10) Pub. No.: US 2006/0130108 A1
(43) Pub. Date: Jun. 15, 2006

(54) Control method for television

(75) Inventor: Sang-sin Koh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/222,807

(22) Filed: Sep. 12, 2005

(30) Foreign Application Priority Data
Dec. 15, 2004 (KR) 2004-0106383

(51) Int. Cl. H04N 7/173

(52) U.S. Cl. 725/110; 725/109; 725/112; 725/113

(57) ABSTRACT

A method of controlling a television having a teleweb function that receives a broadcasting signal and teleweb information of a selected channel from a server providing the broadcasting signal and the teleweb information includes: setting the teleweb function to be in an on state via a user menu; selecting a channel search function which searches channels receiving the teleweb information; setting any channel as a service channel among the searched channels; determining whether a current received channel corresponds to the service channel if the teleweb function is performed by a predetermined key input; and displaying a teleweb-screen of the service channel if the current channel corresponds to the service channel.

### CROSS-REFERENCE TO RELATED APPLICATIONS

This application claims priority from Korean Patent Application No. 2004-0106383, filed on Dec. 15, 2004, in the Korean Intellectual Property Office, the disclosure of which is incorporated herein by reference.

### BACKGROUND OF THE INVENTION

1. Field of the Invention

The present invention relates to a control method for a television, and more particularly, to a control method for a television that allows a user unaccustomed to the teleweb function to efficiently and conveniently set and perform a teleweb function by providing an algorithm including a normal set up/performance of the teleweb function.

2. Description of the Related Art

Generally, a television receives broadcasting signals from broadcasting stations each of which provides a broadcasting signal of a respective channel such as the Korean Broadcasting System (KBS), the Munhwa Broadcasting Corporation (MBC), the Seoul Broadcasting System (SBS), etc. and plays a channel selected by a user.

A teleweb function is expected to be added to television broadcasting systems to provide promptly more information for viewers.

According to the teleweb function, a broadcasting station transmits a broadcasting signal and teleweb information including information such as stocks, weather, news, etc. Then, a television receives the broadcasting signal and the teleweb information from the broadcasting station. At this time, if the television performs the teleweb function while playing a broadcast according to the broadcast signal, the television displays a teleweb-screen providing information which a user needs.

However, a user who is unfamiliar with the teleweb function cannot use the teleweb function in the television effectively.

### SUMMARY OF THE INVENTION

Accordingly, it is an aspect of the present invention to provide a control method for a television providing efficiency and convenience to set and perform a teleweb function to user unaccustomed to the teleweb function by providing an algorithm including a normal setup/performance of the teleweb function.

Additional aspects and/or advantages of the present invention will be set forth in part in the description which follows and, in part, will be obvious from the description, or may be learned by practice of the present invention.

The foregoing and/or other aspects of the present invention are also achieved by providing a method of controlling a television having a teleweb function that receives a broadcasting signal and teleweb information of a selected channel from a server providing the broadcasting signal and the teleweb information comprising: setting the teleweb function to be in an on state via a user menu; selecting a channel search function which searches channels receiving the teleweb information; setting any channel as a service channel among the searched channels; determining whether a current channel receiving the broadcasting signal at present corresponds to the service channel if the teleweb function is performed by a predetermined key input; and displaying a teleweb-screen of the service channel if the current channel receiving the broadcasting signal at present corresponds to the service channel.

According to an aspect of the present invention, the setting the teleweb function to be in an on state comprises determining whether the teleweb function is in the on state if the teleweb function is performed by predetermined key input, and displaying the user menu to set the teleweb function to the on state if the teleweb function is not in the on state.

According to an aspect of the present invention, the setting a service channel comprises determining whether the service channel is in a set state if the teleweb function is performed by the predetermined key input, and displaying a predetermined non-setting message to inform that the service channel is not in the set state if the service channel is not in the set state.

According to an aspect of the present invention, the setting a service channel further comprises displaying an item to select the channel search function, and at the same time displaying the non-setting message; selecting the channel search function in the displayed item; and setting any channel to the service channel among the searched channels.

According to an aspect of the present invention, the displaying the teleweb-screen comprises determining whether the amount of the stored teleweb information is more than a predetermined amount for displaying the teleweb-screen of the service channel if the current channel corresponds to the service channel, and displaying the teleweb-screen according to the stored teleweb information if the amount of the stored teleweb information is more than the predetermined amount.

According to an aspect of the present invention, the displaying the teleweb-screen comprises displaying a predetermined storage message to inform that the teleweb information is stored continuously if the amount of the stored teleweb information is not more than the predetermined amount; and displaying the teleweb-screen according to the stored teleweb information if the amount of the stored teleweb information is more than the predetermined amount.

According to an aspect of the present invention, the displaying the teleweb-screen comprises determining whether the amount of the teleweb information is stored more than a predetermined amount if the teleweb function is performed and the current channel does not correspond to the service channel, and displaying the teleweb-screen according to the stored teleweb information if the amount of the stored teleweb information is more than the predetermined amount.

According to an aspect of the present invention, the displaying the teleweb-screen comprises displaying a predetermined other channel message to inform that the current channel and the service channel are not corresponding if the amount of the stored teleweb information is not more than the predetermined amount.

According to an aspect of the present invention, the displaying the teleweb-screen comprises determining whether the amount of the teleweb information is stored more than a predetermined amount if the teleweb function is performed and the current channel does not correspond to the service channel, displaying the teleweb-screen according to the stored teleweb information if the amount of the stored teleweb information is more than the predetermined amount.

According to an aspect of the present invention, the displaying the teleweb-screen comprises displaying a predetermined other channel message to inform that the current channel and the service channel are not corresponding if the amount of the stored teleweb information is not more than the predetermined amount.

According to an aspect of the present invention, further comprising displaying a switching item to switch the current channel to the service channel on the other channel message; switching the current channel to a channel corresponding to the service channel if the switching item is selected; and displaying the teleweb-screen according to the stored teleweb information if the amount of the stored teleweb information is more than the predetermined amount.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a control block diagram of a television according to the present invention;

FIG. 2 is a control flowchart for a teleweb function setup of a television according to a first embodiment of the present invention;

FIG. 3 is a control flowchart for a teleweb function performance of a television according to the present invention;

FIG. 4 is a control flowchart for a teleweb function setup of a television according to a second embodiment of the present invention;

FIG. 5 illustrates examples of pictures for setting a teleweb function of a television using a menu according to an embodiment of the present invention; and

FIG. 6 illustrates examples of pictures showing storage information and the other channel message which are used to perform a teleweb function of a television according to an embodiment of the present invention.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to like elements throughout.

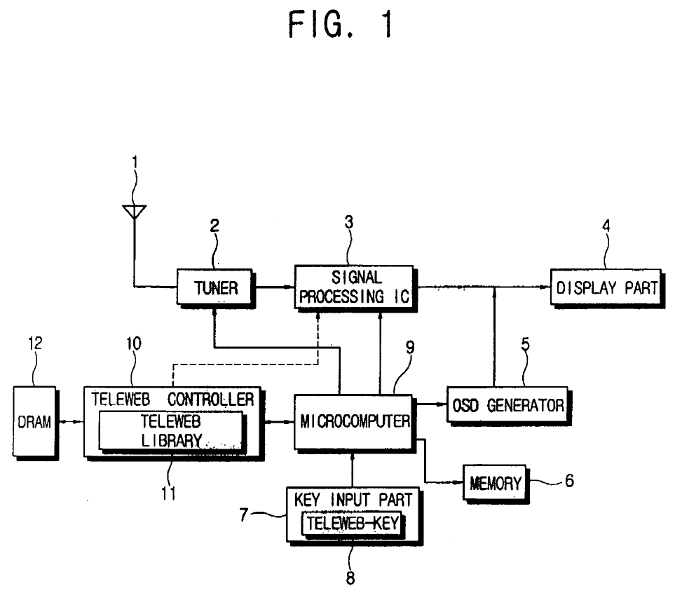

As shown in FIG. 1, a television according to an embodiment of the present invention comprises a display part 4; an antenna 1 to receive a broadcasting signal and teleweb information; a tuner 2 receiving the broadcasting signal and the teleweb information from the antenna 1 and tuning a receiving channel; a signal processing IC 3 to process one of the broadcasting signal from the tuner 2 and the teleweb information from a teleweb controller 10 to be described later for displaying on the display part 4; a key input part 7; a memory 6 to store various information; an OSD (on screen display) generator 5 to generate various messages and a user menu generated by a microcomputer 9 to be described later; a DRAM 12 to store the teleweb information; the teleweb controller 10 controlling the DRAM 12 to store the teleweb information and to output the stored teleweb information to the signal processing IC 3; the microcomputer 9 to control the tuner 2 the signal processing IC 3, the OSD generator 5 and the memory 6 according to input from the key input part 7, and to control the teleweb controller 10 to display a teleweb-screen on the display part 4, if a teleweb-key 8 is selected.

The broadcasting signal and the teleweb information received through the antenna 1 of the television according to the embodiment of the present invention are provided from a server (not shown) providing the broadcasting signal and the teleweb information according to each channel. Here, a teleweb swiftly updates information such as stocks, weather, news, etc. to provide a teleweb-screen similar to an Internet web browser for a user.

The server (not shown) refers to broadcasting stations providing a broadcasting signal of each channel such as the Korean Broadcasting System (KBS), the Munhwa Broadcasting Corporation (MBC), the Seoul Broadcasting System (SBS), etc. A broadcasting station providing the teleweb information among the broadcasting stations transmits the broadcasting signal, and at the same time transmits the teleweb information. Thus, the television providing the teleweb function receives the broadcasting signal and the teleweb information at the same time through the antenna 1.

The key input part 7 is an input apparatus for key input by a user. The key input part 7 includes various handling-keys such as (+)key, (−)key, etc. for adjusting a function of the television. The key input part 7 comprises at least one wireless remote controller (not shown) or wired handling-keys at a television body. Here, it is preferred, but not necessary, that the key input part 7 further comprises the teleweb-key 8 to perform the teleweb function.

The tuner 2 receives the broadcasting signal and the teleweb information from the antenna 1 and tunes a broadcasting signal according to a channel selected by a user through the key input part 7. Then, the tuner 2 outputs only the broadcasting signal of the selected channel received from the antenna 1 to the signal processing IC 3 if the broadcasting station providing the broadcasting signal of the selected channel does not provide the teleweb information. Here, the tuner 2 outputs the broadcasting signal, and at the same time the teleweb information of the selected channel received from the antenna 1 to the signal processing IC 3 if the broadcasting station providing the broadcasting signal of the selected channel provides the teleweb information.

The signal processing IC 3 processes the broadcasting signal inputted from the tuner 2 for displaying on the display part 4 by the microcomputer 9. Here, the signal processing IC 3 processes the teleweb information inputted from the teleweb controller 10 for displaying on the display part 4 as a teleweb-screen by the teleweb controller 10 if the teleweb function is performed.

The OSD generator 5 generates and outputs an OSD signal for displaying a user menu generated by the microcomputer 9 to set the teleweb function to an on state and to select a channel search function for searching a channel having teleweb information, a predetermined non-setting message to indicate that a service channel is not in a set state, a predetermined information loading message to indicate that teleweb information is stored continuously, and a predetermined other channel message to indicate that the current channel does not correspond to the service channel.

The memory 6, under control of the microcomputer 9, stores channel information of channels which provide a teleweb service, and service channel information of a channel which is set in the service channel among the channels providing the teleweb service.

If the teleweb channel search function is performed under the control of the microcomputer 9 (to be described later), the teleweb controller 10 searches the channels that provide the teleweb information among the respective channels tuned sequentially by the tuner 2, and outputs the channel information of the channels that provide the teleweb information to the microcomputer 9. The teleweb controller 10 stores the service channel information of a channel that is set as the service channel inputted from the microcomputer 9. The teleweb controller 10 stores the teleweb information in the DRAM 12 if the service channel is tuned and the teleweb information is outputted from the tuner 2. Then, a broadcasting signal according to the service channel is processed by the signal processing IC 3 and displayed on the display part 4.

Also, the teleweb controller 10 determines whether the amount of the teleweb information stored in the DRAM 12 is more than a predetermined amount if a storage state request signal is inputted from the microcomputer 9. Here, it is preferred, but not necessary, that the predetermined amount comprises an amount sufficient for displaying an initial teleweb-screen. The teleweb controller 10 outputs a first response signal to the microcomputer 9, converts the teleweb information stored in the DRAM 12 into teleweb information of a state that can be processed by the signal processing IC 3, and outputs the converted teleweb information to the signal processing IC 3 if the amount of the teleweb information stored in the DRAM 12 is more than the predetermined amount. Thus, a broadcasting-screen according to the service channel is converted into a teleweb-screen according to the service channel, so that a user will get the wanted information from the teleweb-screen.

Here, the teleweb controller 10 outputs a second response signal to the microcomputer 9 and detects continuously whether the teleweb information stored in the DRAM 12 is not more than the predetermined amount. According to the detection result, the teleweb controller 10 outputs the first response signal to the microcomputer 9 to convert the teleweb information stored in the DRAM 12 into teleweb information of a state that can be processed by the signal processing IC 3 and outputs the converted teleweb information to the signal processing IC 3 if the amount of the teleweb information stored in the DRAM 12 is more than the predetermined amount. It is preferred, but not necessary, that the function above described be performed by a teleweb library that is stored in the teleweb controller 10.

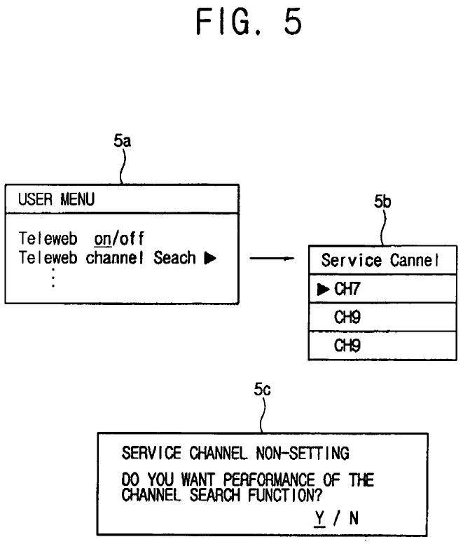

The microcomputer 9 controls the OSD generator 5 to display the user menu (5a) as shown in FIG. 5 if a user handling the key input part 7 selects the user menu. The microcomputer 9 stores an on state if the teleweb function is activated in the user menu 5a. Also, the microcomputer 9 controls the teleweb controller 10 to search the teleweb service channel, and the tuner 2 and the signal processing IC 3 to tune sequentially the broadcasting signal of the respective channels received from the antenna 1 and to display sequentially the broadcasting signal if the teleweb channel search function is selected.

Then, the microcomputer 9 stores the channel information in the memory 6 which is inputted from the teleweb controller 10 about channels providing the teleweb information, and controls the OSD generator 5 to display the channels providing the teleweb information as shown in the service channel selection menu 5b in FIG. 5. Here, the microcomputer 9 stores the channel (e.g., channel 7) selected by the key input part 7 in the service channel selection menu 5b in the memory 6, and outputs the service channel information (e.g., channel 7) set as the teleweb service channel to the teleweb controller 10. Thus, the microcomputer 9 finishes the setting for the teleweb function.

Then, the microcomputer 9 controls the tuner 2 to tune the broadcasting signal according to the channel selected by the key input part 7 and the signal processing IC 3 to play the broadcasting signal of the channel like a conventional microcomputer. Also, the teleweb controller 10 stores the teleweb information that is inputted with the broadcasting signal from the tuner 2 in the DRAM 12 if the channel of the broadcasting signal that is played at present is the same channel as the teleweb service channel (e.g., channel 7) stored in the memory 6.

Here, the microcomputer 9 determines whether the channel played at present and the teleweb service channel (e.g., channel 7) stored in the memory 6 are the same if the teleweb function is performed in response to an input from the teleweb-key 8. The microcomputer 9 requests the storage state of the teleweb information to the teleweb controller 10 if the current channel being played and the teleweb service channel (e.g., channel 7) are the same. Thus, the microcomputer 9 controls the signal processing IC 3 and the teleweb controller 10 to convert the broadcasting-screen displayed at present on the display part 4 into the initial teleweb-screen if the microcomputer 9 receives the first response signal to inform that the amount of the teleweb information stored in the DRAM 12 is sufficient to display the beginning teleweb-screen. Then, the microcomputer 9 outputs a key signal according to the item selected by the key input part 7 in the teleweb-screen to the teleweb controller 10. Thus, the teleweb controller 10 provides the teleweb information according to the item selected in the teleweb-screen to the signal processing IC 3.

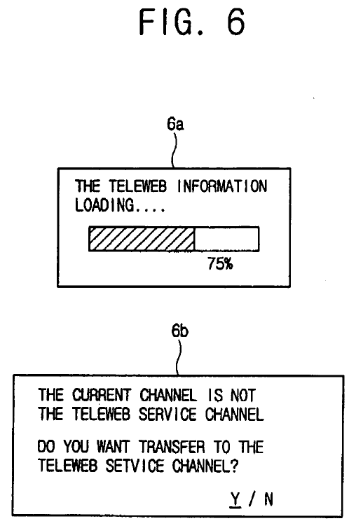

Here, the microcomputer 9 controls the OSD generator 5 to display the predetermined information loading message (refer to 6a in FIG. 6) to inform that teleweb information is stored continuously if the microcomputer 9 receives the second response signal to inform that the amount of the teleweb information stored in the DRAM 12 is not sufficient to display the initial teleweb-screen. Then, the microcomputer 9 controls the signal processing IC 3 and the teleweb controller 10 to display the teleweb-screen, if the microcomputer 9 receives the first response signal from the teleweb controller 10 to inform that the amount of the teleweb information stored in the DRAM 12 is sufficient for displaying the initial teleweb-screen, after a predetermined period of time.

Also, the microcomputer 9 requests the storage state of the teleweb information from the teleweb controller 10 if the current channel being played and the teleweb service channel (e.g., channel 7) are not the same. Thus, the microcomputer 9 controls the signal processing IC 3 and the teleweb controller 10 to convert the broadcasting-screen presently displayed on the display part 4 into the initial teleweb-screen of the teleweb service channel which is not the channel of the broadcasting-screen presently displayed if the microcomputer 9 receives the first response from the teleweb controller 10.

Also, the microcomputer 9 controls the OSD generator 5 to display another channel message (as shown by 6b in FIG. 6) to inform that the current channel does not correspond to the teleweb service channel, if the current channel is not the teleweb service channel (e.g., channel 7) and the microcomputer 9 requests the storage state of the teleweb information from the teleweb controller 10 to thereby be inputted the second response signal. The microcomputer 9 controls the tuner 2 to convert the current broadcasting channel into the teleweb service channel (e.g., channel 7) if transfer to the teleweb service channel is selected in the other channel message 6b. Thus, the microcomputer 9 controls the signal processing IC 3 and the OSD generator 5 to play the broadcasting according to the teleweb service channel (e.g., channel 7) and to display the information loading message 6a until the first response signal is inputted from the teleweb controller 10 at the same time the broadcasting of the teleweb service channel (e.g., channel 7) is played. Then, the microcomputer 9 controls the signal processing IC 3 and the teleweb controller 10 to convert the broadcasting-screen presently displayed on the display part 4 into the initial teleweb-screen of the teleweb service channel if the microcomputer 9 receives the first response signal to inform that the amount of teleweb information stored in the DRAM 12 is sufficient for displaying the initial teleweb-screen after a predetermined period of time.

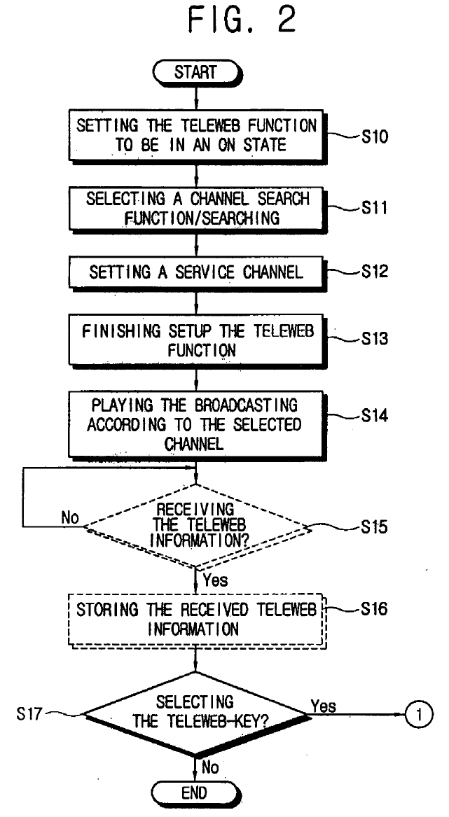

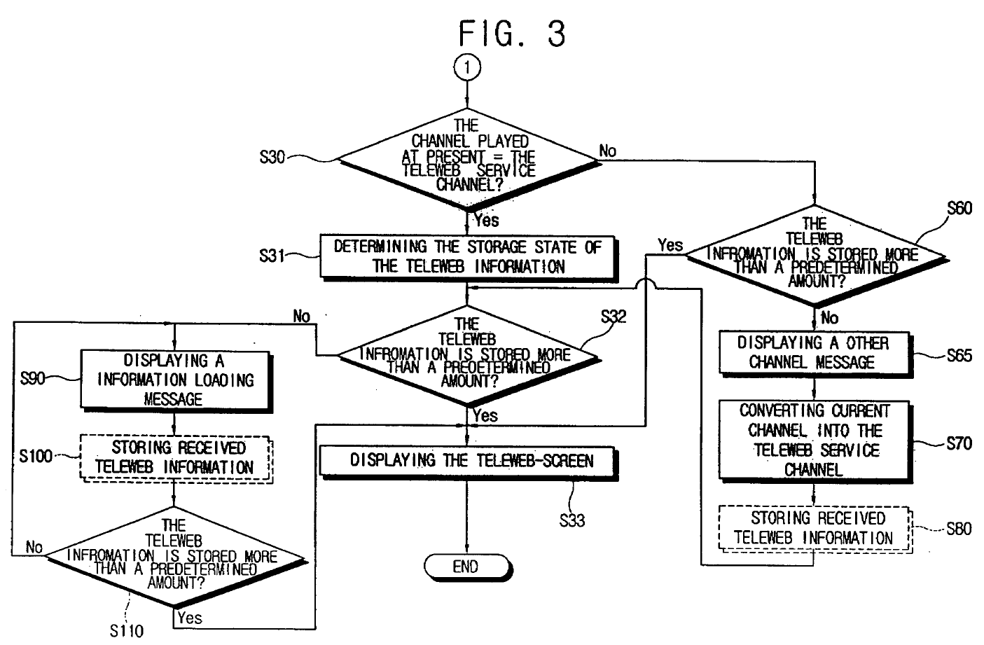

Referring to FIGS. 2 and 3, a control flow of the television according to the present invention will be described.

The microcomputer 9 controls the OSD generator 5 to display the user menu (5a) if the user menu is selected, and a user manipulates the key input part 7 to activate the teleweb function at operation S10. Then, the user selects the channel search function of the user menu (5a) to search for a channel receiving teleweb information. Thus, the teleweb controller 10 searches the channels that provide the teleweb information at operation S11. The microcomputer 9 displays the service channel selection menu (5b) based on the foregoing searching result, and sets the teleweb service channel (e.g., channel 7) based on a channel which is selected by the user at operation S12. The microcomputer 9 finishes the setting of the teleweb function at operation S13. Then, the microcomputer 9 controls the tuner 2 to tune the broadcasting signal according to the channel selected by the key input part 7 and the signal processing IC 3 to play the broadcasting signal of the channel at operation S14. Then, the teleweb controller 10 stores the teleweb information outputted with the broadcasting signal from the tuner 2 in the DRAM 12 at operation S16 if a channel of the broadcasting signal presently being played corresponds to the predetermined teleweb service channel (CH 7) at operation S15. The microcomputer 9 determines whether the teleweb function is performed by the input of the teleweb-key 8 at operation S17. The microcomputer 9 determines whether the channel presently being played and the teleweb service channel (CH 7) stored in the memory 6 are the same when the teleweb-key 8 is selected at operation S30. The microcomputer 9 requests the storage state of the teleweb information from the teleweb controller 10 if the channel presently being played and the teleweb service channel (CH 7) are the same at operation S31. Thus, the microcomputer 9 determines whether the amount of the teleweb information stored in the DRAM 12 is more than the predetermined amount for displaying the initial teleweb-screen based on the first response signal and the second response signal from the teleweb controller 10 at operation S32. The microcomputer 9 controls the signal processing IC 3 and the teleweb controller 10 to convert the broadcasting-screen of the present channel (CH 7) displayed on the display part 4 into the initial teleweb-screen of the channel (CH 7) if the microcomputer 9 receives the first response from the teleweb controller 10 at operation S33.

If the microcomputer 9 receives the second response signal from the teleweb controller 10 at operation S32, the microcomputer 9 controls the OSD generator 5 to display the information loading message (6a) at operation S90. Then, the teleweb controller 10 continues to store the teleweb information inputted from the tuner 2 in the DRAM 12 at operation S100. Thus, the microcomputer 9 continues to determine whether the amount of the teleweb information stored in the DRAM 12 is more than the predetermined amount based on the response signal from the teleweb controller 10 at operation S110. The microcomputer 9 performs the foregoing operation S33 if the microcomputer 9 receives the first response signal from the teleweb controller 10 to inform that the amount of the teleweb information stored in the DRAM 12 is sufficient for displaying the initial teleweb-screen after a predetermined period of time.

Here, the microcomputer 9 requests the storage state of the teleweb information from the teleweb controller 10 if the channel presently being played is not the teleweb service channel (CH 7) at operation S30. Thus, the microcomputer 9 determines whether the amount of the teleweb information stored in the DRAM 12 is more than the predetermined amount for displaying the initial teleweb-screen based on the first response signal and the second response signal from the teleweb controller 10 at operation S60. The microcomputer 9 controls the signal processing IC 3 and the teleweb controller 10 to convert the broadcasting-screen of the present channel displayed on the display part 4 into the initial teleweb-screen of the teleweb service channel (CH 7) if the microcomputer 9 receives the first response from the teleweb controller 10 at operation S33.

Also, if the microcomputer 9 receives the second response signal from the teleweb controller 10 at operation S60, the microcomputer 9 controls the OSD generator 5 to display the other channel message (6b) to inform that the current channel and the teleweb service channel are not the same at operation S65. The microcomputer 9 controls the tuner 2 to convert the current broadcasting channel into the teleweb service channel (CH 7) if transfer to the teleweb service channel is selected using the other channel message 6b at operation S70. Thus, the teleweb controller 10 continues to store the teleweb information outputted with the broadcasting signal from the tuner 2 in the DRAM 12 at operation S80. Then, the microcomputer 9 performs the foregoing operation S32.

As described above, when the user sets the teleweb function, the controlling method of the television according to the present invention helps the user to easily set the teleweb function with the user menu. Also, during a process of entering the teleweb mode or displaying the initial teleweb-screen, the controlling method of the television according to the present invention allows a user unaccustomed to a teleweb function to conveniently perform a teleweb function by providing various messages to implement the teleweb mode.

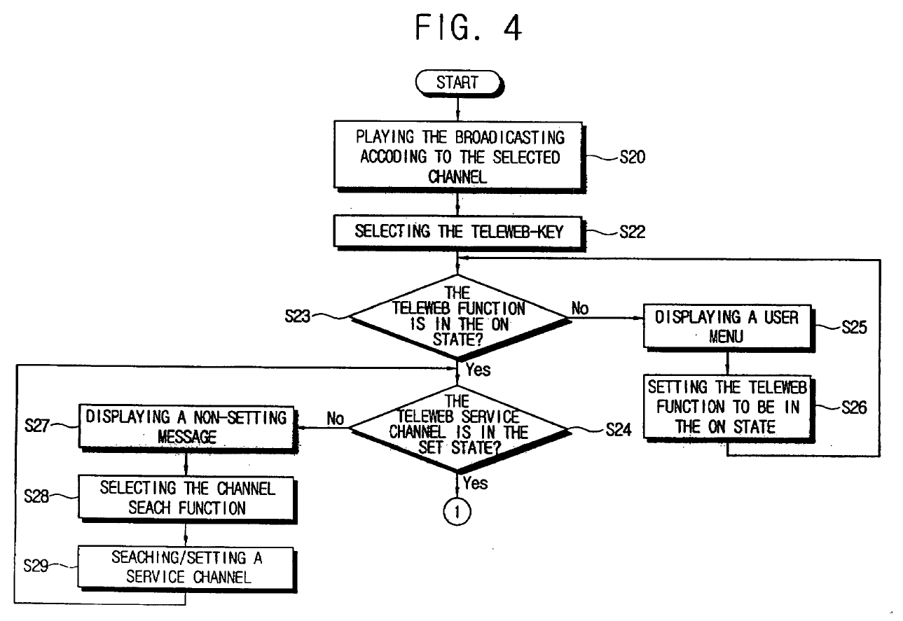

Here, FIG. 4 illustrates another embodiment of the television according to the present invention for setting the teleweb function. The embodiment is applied to a case in which the user selects performance of the teleweb function when setting of the teleweb function (S10˜S13 in FIG. 2) is not finished.

The microcomputer 9 controls the tuner 2 to tune the broadcasting signal of the channel selected by the key input part 7, and the signal processing IC 3 to play the broadcasting signal of the channel at operation S20. Then, the teleweb function is performed according to the input of the teleweb-key 8 at operation S22. The microcomputer 9 determines whether the teleweb function is in the on state at operation S23. The microcomputer 9 controls the OSD generator 5 to display the user menu (5a) if the teleweb function is not in the on state at operation S25. The operation S25 allows the teleweb function to be set to the on state. Thus, the microcomputer 9 turns on the teleweb function if the teleweb function is selected using the user menu (5a) at operation S26. If the teleweb function is in the on state at operation S23, the microcomputer 9 determines whether the teleweb service channel is in the set state at operation S24. The microcomputer 9 controls the OSD generator 5 to display a service channel non-setting message (5c) if the teleweb service channel is not in set state at operation S27. The operation S27 allows the setting of the teleweb service channel. The user selects the channel search function in the service channel non-setting message (5c) at operation S28. Thus, the teleweb controller 10 searches the channels that provide the teleweb information, and the microcomputer 9 displays the service channel selection menu (5b) based on the foregoing searching result. The microcomputer 9 sets the teleweb service channel (CH 7) based on a channel which is selected by the user in the service channel selection menu (5b) at operation S29. The microcomputer 9 determines that the setting for the teleweb function is normally finished and allows to enter the state for performing the teleweb function if the teleweb service channel is in the set state at operation S24.

As described above, the controlling method for setting the teleweb function of the television according to the present invention helps the user unaccustomed to a teleweb function to easily set the teleweb function by providing setting menus and messages to assist the setting process for the teleweb function when the teleweb-key 8 is selected.

With the foregoing process, the controlling method of the television according to the present invention displays setting menus to carry out the setting process for the teleweb function and displays various messages to allow entry to the teleweb mode if the teleweb function is performed when the teleweb function is not normally set.

Thus, when the user sets and performs the teleweb function, the controlling method of the television according to the present invention allows a user unaccustomed to setting and performing the teleweb function to conveniently and efficiently set and perform the teleweb function by providing an algorithm for a normal set up/performance of the teleweb function.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling a television having a teleweb function that receives a broadcasting signal and teleweb information of a selected channel from a server providing the broadcasting signal and the teleweb information comprising:
setting the teleweb function to be in an on state via a user menu;
selecting a channel search function which searches channels having the teleweb information;
setting any channel as a service channel among the searched channels having the teleweb information;
determining whether a current channel played by the television corresponds to the service channel if the teleweb function is performed in response to a predetermined key input; and
displaying a teleweb-screen of the service channel if the current channel played by the television corresponds to the service channel.

2. The method of controlling the television according to claim 1, wherein the setting the teleweb function to be in an on state comprises determining whether the teleweb function is in the on state if the teleweb function is performed in response to a predetermined key input, and displaying the user menu to set the teleweb function to the on state if the teleweb function is not in the on state.

3. The method of controlling the television according to claim 2, wherein the setting a service channel comprises determining whether the service channel is in a set state if the teleweb function is performed in response to the predetermined key input, and displaying a predetermined non-setting message to indicate that the service channel is not in the set state if the service channel is not in the set state.

4. The method of controlling the television according to claim 3, further comprising displaying an item to select the channel search function, and at the same time displaying the non-setting message; selecting the channel search function in the displayed item; and setting any channel to the service channel among the searched channels.

5. The method of controlling the television according to claim 4, wherein the displaying the teleweb-screen comprises determining whether an amount of the teleweb information that is stored is more than a predetermined amount for displaying the teleweb-screen of the service channel if the current channel corresponds to the service channel, and displaying the teleweb-screen according to the stored teleweb information if the amount of the stored teleweb information is more than the predetermined amount.

6. The method of controlling the television according to claim 5, wherein the displaying the teleweb-screen comprises displaying a predetermined storage message to indicate that the teleweb information is stored continuously if the amount of the stored teleweb information is not more than the predetermined amount; and displaying the teleweb-screen according to the stored teleweb information if the amount of the stored teleweb information is more than the predetermined amount.

7. The method of controlling the television according to claim 1, wherein the displaying the teleweb-screen comprises determining whether an amount of the teleweb information that is stored is more than a predetermined amount for displaying the teleweb-screen of the service channel if the current channel corresponds to the service channel, and displaying the teleweb-screen according to the stored teleweb information if the amount of the stored teleweb information is more than the predetermined amount.

8. The method of controlling the television according to claim 7, wherein the displaying the teleweb-screen comprises displaying a predetermined storage message to indicate that the teleweb information is stored continuously if the amount of the stored teleweb information is not more than the predetermined amount; and displaying the teleweb-screen according to the stored teleweb information if the amount of the stored teleweb information is more than the predetermined amount.

9. The method of controlling the television according to claim 1, wherein the displaying the teleweb-screen comprises determining whether an amount of the teleweb information that is stored is more than a predetermined amount if the teleweb function is performed and the current channel does not correspond to the service channel, and displaying the teleweb-screen according to the stored teleweb information if the amount of the stored teleweb information is more than the predetermined amount.

10. The method of controlling the television according to claim 9, wherein the displaying the teleweb-screen comprises displaying a predetermined other channel message to indicate that the current channel and the service channel are not corresponding if the amount of the stored teleweb information is not more than the predetermined amount.

11. The method of controlling the television according to claim 10, further comprising displaying a switching item to switch the current channel to the service channel on the other channel message; switching the current channel to a channel corresponding to the service channel if the switching item is selected; and displaying the teleweb-screen according to the stored teleweb information if the amount of the stored teleweb information is more than the predetermined amount.

12. The method of controlling the television according to claim 4, wherein the displaying the teleweb-screen comprises determining whether an amount of the teleweb information that is stored is more than a predetermined amount if the teleweb function is performed and the current channel does not correspond to the service channel, displaying the teleweb-screen according to the stored teleweb information if the amount of the stored teleweb information is more than the predetermined amount.

13. The method of controlling the television according to claim 12, wherein the displaying the teleweb-screen comprises displaying a predetermined other channel message to indicate that the current channel and the service channel are not corresponding if the amount of the stored teleweb information is not more than the predetermined amount.

14. The method of controlling the television according to claim 13, further comprising displaying a switching item to switch the current channel to the service channel on the other channel message; switching the current channel to a channel corresponding to the service channel if the switching item is selected; and displaying the teleweb-screen according to the stored teleweb information if the amount of the stored teleweb information is more than the predetermined amount.
